(19) United States
(12) Patent Application Publication
(10) Pub. No.: US 2015/0280311 A1
(43) Pub. Date: Oct. 1, 2015

(54) Systems and Methods for a Surface-Mountable Stamped Antenna

(71) Applicant: MOTOROLA MOBILITY LLC, CHICAGO, IL (US)

(72) Inventors: Lynn M. Greetis, Palatine, IL (US); Se Hun Chung, Libertyville, IL (US); Kah Jon Goo, Carpentersville, IL (US); Soo Won Hong, Vernon Hills, IL (US); Michael L. Johnson, Carol Stream, IL (US)

(73) Assignee: MOTOROLA MOBILITY LLC, CHICAGO, IL (US)

(21) Appl. No.: 14/229,080

(22) Filed: Mar. 28, 2014

(51) Int. Cl. H01Q 1/24; B23K 31/02; B23K 1/20; H01Q 1/50; B23K 1/00

(52) U.S. Cl. CPC H01Q 1/243; H01Q 1/50; B23K 1/0016; B23K 1/20; B23K 31/02

(57) ABSTRACT

Systems and methods are provided for an antenna structure (100) configured for attachment to a circuit board (102). The antenna structure includes a main body (103) having a first end (105), a second end (107) opposite from the first end, and a side (109) extending between the first end and the second end. The antenna structure further includes a first support (104) formed from the first end, a second support (106) formed from the second end, and a third support (108) extending from the side of the main body. The main body, the first support, the second support, and the third support are formed from a single conductive sheet. Each of the supports is mechanically attached to the circuit board, and only one of the supports is electrically coupled to an antenna feed of the circuit board.

### FIELD

This application generally relates to wireless communication devices. In particular, the application relates to platforms and techniques for providing a surface-mountable stamped antenna in wireless communications devices.

### BACKGROUND

Modern wireless communication devices, including mobile telephones and other portable radio communication devices, offer an expanded set of features that are increasingly dependent on bandwidth and require complex circuitry for performing the multitude of functions that enable those features. One such feature is the flexibility to operate under multiple communications standards and/or across multiple bands of operation to enable interoperability between existing and emerging radio access technologies (RATs) and/or to accommodate international business and recreational travelers.

Competing with the increasing demands on the radio portion of the mobile device is the constant push to minimize the size, weight, power consumption, and cost of mobile devices. Existing strategies to help minimize these characteristics can include reducing the number of components and/or connections within the device and performing multiple functions using the same components. For example, many commercially-available mobile devices now include one or more multi-band antennas that are capable of selectively operating in one of a plurality of frequency bands at a time. This arrangement reduces the total required antenna volume when compared against the alternative of a greater quantity of antennas, each having a fixed and narrower bandwidth. Another size-reducing strategy includes placing an internal antenna and other device components (e.g., speaker, microphone, camera, etc.) within the same antenna volume, but in radio-frequency (RF) isolation from each other. With respect to reducing the cost of a mobile device, a variety of manufacturing techniques have been developed with the goal of improving manufacturing consistency, and thereby, antenna performance, while also reducing tooling and/or lead time and costs. However, each existing technology has its own combination of benefits and drawbacks.

For example, metal-stamping technology is one cost-effective technique for manufacturing internal antennas. The metal-stamping technique involves forming a desired antenna shape from sheet metal by cutting out the overall flattened shape of the antenna and then bending and/or stamping the cut piece until the desired antenna shape is formed. Typically, a metal-stamped antenna further includes a plastic carrier that is heat-staked to the metal-stamped piece (or radiator). Metal-stamped antennas are typically included in a plastic housing portion of the mobile device and are coupled to the printed circuit board (PCB) through an electrical contact, such as a spring contact or “finger,” coupled to the PCB. Spring contacts are typically made from the same sheet metal used to form the antenna, thus adding to the cost-savings. Metal-stamped antennas can be relatively easy to tune during the production process, as long as the parameter needing adjustment is already included in the tooling design.

As another example, internal antennas may be made using flex circuit technology. This technique may provide a higher level of consistency, but is also relatively more expensive, for example, as compared to metal-stamping. Flex antennas wrap around another two-dimensional surface and are typically included in the plastic housing portion of the mobile device. Since a flex antenna itself cannot provide connecting features, other parts, such as metal spring fingers or pogo pins, are required to make electrical contact with the PCB.

As yet another example, Laser Direct Structuring (LDS) may be one of the most expensive manufacturing processes, but also provides a higher level of consistency, especially compared to metal-stamping and flex techniques. Unlike metal-stamped and flex antennas, which combine two separate parts, the LDS antenna is formed from the plastic structure supporting it. Specifically, the LDS process uses a laser beam to draw an antenna pattern onto a molded piece of nonplateable thermoplastic. The laser transforms the patterned areas into a plateable surface, and a plating process deposits copper onto the patterned areas of the plastic piece to form the antenna. The LDS technique may provide shorter tooling time because a given antenna pattern can be added or adjusted by simply uploading a new pattern file to the laser. However, like flex antennas, LDS antennas require a separate part, such as a metal spring contact, to form an electrical contact with the PCB.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a top perspective view of an example antenna structure coupled to an example printed circuit board in accordance with some embodiments.

FIG. 2 is an elevation view of an example antenna structure coupled to an example printed circuit board in accordance with some embodiments.

FIG. 3 is an inverted view of an example printed circuit board configured to be coupled to an example antenna structure in accordance with some embodiments.

FIG. 4 is a partial, exploded perspective view of an example electronic device including an example antenna structure in accordance with some embodiments.

FIG. 5 is a side perspective view of an example antenna coupled to an example printed circuit board in accordance with some embodiments.

FIG. 6 is a top perspective view of the antenna shown in FIG. 5 in accordance with some embodiments.

FIG. 7 is a flow diagram illustrating an example process for manufacturing an antenna in accordance with some embodiments.

FIG. 8 is a flow diagram illustrating an example sub-process of the manufacturing process shown in FIG. 7 in accordance with some embodiments.

### DETAILED DESCRIPTION

Systems and methods disclosed herein provide an antenna structure that is manufactured using metal-stamping techniques and can be attached directly to a surface of a printed circuit board (PCB) included in a mobile device. In some example embodiments, the antenna structure has three support legs coupled to contact pads included on a surface of the PCB, one of the contact pads being electrically connected to an antenna feed of the PCB. In this regard, the antenna structure may be referred to as a “surface-mountable” antenna. The metal-stamped, surface-mountable antenna structure disclosed herein also functions as a multi-band antenna configured to operate in a plurality of frequency bands when coupled to wireless communication circuitry included in the mobile device.

According to example embodiments, the surface-mountable, stamped antenna structure can include a conductive body with two opposing end legs and a side leg. Metal-stamping techniques can be used to form, from the conductive body, a first support at one end, a second support at the other end, and a third support extending from the side, so as to form a bridge-like structure. The three antenna supports can be mechanically attached to respective contact pads included on the PCB of the mobile device, using, for example, a reflow soldering technique that melts solder paste included on the contact pads and then cools the solder to create, or solidify, a mechanical connection to the antenna supports. According to embodiments, only one of the contact pads may be electrically coupled to an antenna feed of the PCB, such as, for example, the contact pad designated for the third support, and the remaining contact pads may be non-grounded.

In some embodiments, the antenna structure further includes a fourth support extending from the side of the conductive body, the fourth support being coupled to one of the non-grounded contact pads. In such embodiments, the third and fourth supports may be placed equidistant from a centroid of the conductive body, so as to form a symmetrically shaped, or balanced, antenna structure that is easier to maneuver when picking and placing the antenna structure on the PCB. Example embodiments further include placing the conductive body above a connector (such as, e.g., a universal serial bus (USB) connector) included on the PCB, so that the antenna structure forms a bridge over the connector.

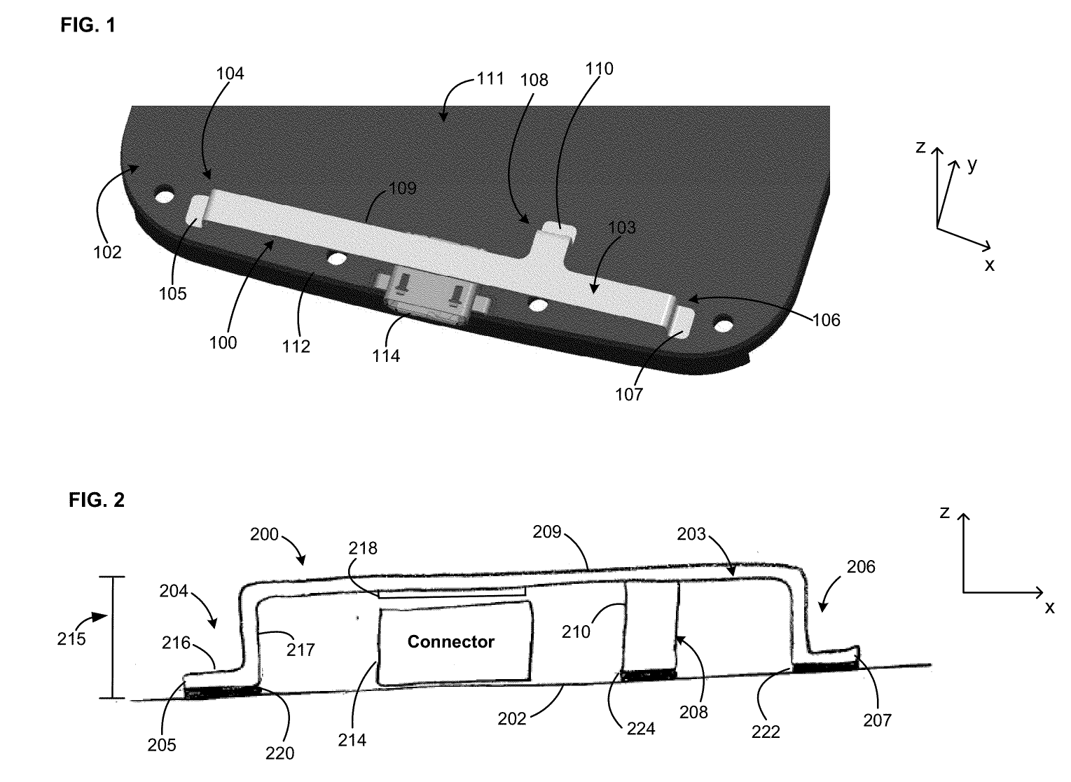

FIG. 1 depicts an example antenna structure 100 consistent with some embodiments. In embodiments, the antenna structure 100 can be a bridge-like structure that includes a plurality of support legs 104, 106, 108 attached to a surface of a printed circuit board (“PCB”) 102 and a main body 103 suspended above the PCB 102. The antenna structure 100 and the PCB 102 may be included in any type of electronic device (not shown) that includes one or more wireless communications transmitters or receivers, such as, for example, a mobile communications device.

As illustrated, the antenna structure 100 includes a first support 104 formed at a first end 105 of the main body 103 and a second support 106 formed at a second end 107 of the main body 103. As shown, the second end 107 is positioned opposite from the first end 105 along a length of the main body 103. As such, the first support 104 and the second support 106 can be attached to the PCB 102 adjacent to opposing sides of the PCB 102. The antenna structure 100 also includes a third support 108 extending from a side 109 of the main body 103. As shown, the side 109 extends between the first end 105 and the second end 107 along the length of the main body 103. In embodiments, the third support 108 is formed from a side protrusion 110 of the main body 103. For example, as shown, the side protrusion 110 can project or extend out from the side 109 of the main body 103 towards a center of the PCB 102. As such, the third support 108 can be attached to the PCB 102 adjacent to a central portion 111 of the PCB 102. Although a particular physical implementation is shown, other configurations of legs may also be useful.

According to embodiments, attachment of the first support 104, the second support 106, and the third support 108 to the PCB 102 can cause the main body 103 of the antenna structure 100 to be suspended or elevated at a predetermined z-axis height above the PCB 102. For example, each of the first support 104, the second support 106, and the third support 108 can be a substantially “L-shaped” structure that includes a horizontal base portion in parallel connection with the PCB 102 and a vertical support portion that is perpendicular to the PCB 102. And each of the first support 104, the second support 106, and the third support 108 can have an overall height that is substantially equal to the predetermined height of the main body 103. In other embodiments, each leg may have a different height, one leg may be shorter than the others, one leg may be taller than the others, or other implementations. Generally, individual leg heights would be affected by the desired external housing design for the electronic device.

The antenna structure 100 may be any suitable type of antenna, such as, e.g., an inverted L-antenna, dual inverted L-antenna, inverted-F antenna, or hybrids of these antenna structures. Further, the antenna structure 100 may be capable of serving any of a number of antenna functions related to sending and receiving data. In some embodiments, the antenna structure 100 may be configured to support various types of wireless communications (or RATs), including non-cellular network communications (e.g., Global Positioning System (GPS), Near Field Communication (NFC), Bluetooth, WiFi, etc.) and/or voice and data cellular telephone communications (e.g., Global System for Mobile Communications (GSM), Code Division Multiple Access (CDMA), Universal Mobile Telecommunications System (UMTS), Long Term Evolution (LTE), etc.). In some embodiments, the antenna structure 100 may be a “multi-band” antenna tuned to a plurality of the frequency bands associated with the RATs supported by the PCB 102, or more specifically, wireless communication circuitry (not shown) included on the PCB 102. Further, according to some embodiments, the antenna structure 100 may be configured as any one of a transmit (Tx) antenna that only sends voice and/or data communications, a receive (Rx) antenna that only receives voice and/or data communications, or a transmit/receive (Tx/Rx) antenna that both sends and receives voice and/or data communications.

The specific functionality of the antenna structure 100 may be determined by a number of factors. For example, the region in which the antenna structure 100 is placed can determine the size, geometry, and/or layout of the available antenna volume, which can affect the antenna function options. In general, Tx/Rx antennas (also referred to as “main antennas”) may require more antenna volume, than, for example, Tx antennas or Rx antennas at least because Tx/Rx antennas need more bandwidth to cover both transmit and receive functions. Further, larger antenna volumes can allow for more flexibility in antenna banding (e.g., able to be tuned to more frequencies). Accordingly, in some embodiments, the main Tx/Rx antenna of the electronic device is typically placed within the largest, discrete antenna volume within the device. As another example, the specific function of the antenna structure 100 can also depend on the particular communication needs of the electronic device in which the antenna structure 100 and PCB 102 are located, including, for example, the different RATs, frequency bands, regions, and/or wireless carriers supported by the device.

In the illustrated embodiment, the antenna structure 100 is a main Tx/Rx antenna coupled adjacent to a y-axis bottom end 112 of the PCB 102, and a length of the antenna structure 100 extends across a majority of the bottom end 112. In embodiments, certain features associated with the bottom end 112 of the PCB 102 may allow the antenna structure 100 to have a longer length and therefore, greater bandwidth capabilities, when compared to other locations of the PCB 102. For example, generally speaking, the bottom portion of the PCB 102 may have a larger antenna volume (e.g., contains larger keepout clearances), fewer electronic components that can cause performance-abating interference with antenna functions, and/or more surface area for mounting the antenna structure 100 to the PCB 102. In other embodiments, the antenna structure 100 may be placed at other locations of the PCB 102 that meet one or more of the above criteria, such as, for example, the top left or right corners (not shown) of the PCB 102. As will be appreciated, a length and/or shape of the antenna structure 100 may need to be adjusted to fit other areas of the PCB 102. For example, in order to fit into a top left corner of the PCB 102, the main body 103 may be formed into an inverted L-shape. In such example embodiment, the first support 104 and the second support 106 may still be formed at the respective ends 105 and 107 of the main body 103, and the third support 108 may extend from the side 109 of one of the legs of the L-shape, towards the central portion 111 of the PCB 102. Alternatively, the third support 108 may extend from an interior corner of the L-shape. Because the L-shape does not have to be symmetrical, there are a variety of design options available for positioning the supports.

According to embodiments, the bridge-like structure of the antenna structure 100 can allow the antenna structure 100 to be placed over, and out of contact with, other conductive elements (e.g., electronic components) of the PCB 102. For example, in the illustrated embodiment, the antenna structure 100 is suspended above a connector 114 that is also coupled adjacent to the bottom end 112 of the PCB 102. In embodiments, the predetermined height of the main body 103 can be selected based on a height of any conductive elements located below, or adjacent to, the antenna structure 100. Also, the predetermined height of the main body 103 can be selected based on a desired exterior z-axis thickness at any point of the electronic device around the antenna. In the illustrated embodiment, the predetermined height of the main body 103 may be selected to be at least greater than a height of the connector 114, so to as to avoid contact between the connector 114 and the antenna structure 100. In some embodiments, an insulator (not shown) may be coupled to an underside of the main body 103 (e.g., between the antenna structure 100 and the connector 114) to further promote isolation of the antenna structure 100. As an example, the insulator (e.g., a non-conductive tape) may prevent accidental contact between the antenna structure 100 and conductive elements located below the main body 103 if, for example, deformation of the antenna structure 100 causes the main body 103 to sag or bend down towards the connector 114. According to embodiments, the connector 114 may be any type of cable connector for connecting a charging and/or data cable (not shown) to the PCB 102. In the illustrated embodiment, the connector 114 is a female Universal Serial Bus (USB) connector (or “socket”) configured to receive a male USB connector (or “plug”). For the sake of brevity, FIG. 1 shows only the connector 114 and the antenna structure 100 coupled to the PCB 102. As will be appreciated, the PCB 102 may include a multitude of other electronic components or conductive elements that are not shown or discussed herein.

In embodiments, each of the first support 104, the second support 106, and the third support 108 can be mechanically attached to the PCB 102. In some embodiments, the PCB 102 includes a plurality of contact pads (not shown) that are placed at predetermined surface locations in accordance with an intended location of the antenna structure 100. For example, each contact pad may be designated for a respective one of the first support 104, the second support 106, and the third support 108, and the predetermined surface location of the contact pad may correspond to the relative location of the designated support within the antenna structure 100 (e.g., at the first end 105, the second end 107, or the side protrusion 110). In some embodiments, each of the contact pads may include solder paste, or other conductive adhesive, for mechanically securing the designated support of the antenna structure 100.

Further, according to embodiments, at least one of the first support 104, the second support 106, and the third support 108 can be electrically coupled to an antenna feed (not shown) of the PCB 102. In the illustrated embodiment, the third support 108 is electrically coupled to the antenna feed. In some embodiments, the contact pad designated for the third support 108 may be electrically coupled to the antenna feed in order to provide the antenna feed connection. In embodiments, the side protrusion 110 may be positioned at a predetermined side location along the side 109 of the main body 103. In some embodiments, the predetermined side location may be selected based on the location of the antenna feed on the PCB 102. In other embodiments, the predetermined side location may be selected based, at least partially, on other factors. For example, the predetermined side location may be selected in reference to a balance center of the antenna structure 100, so as to ease maneuvering of the antenna structure 100 during manufacturing and/or while picking and placing the structure 100 on the PCB 102.

According to embodiments, the antenna structure 100 can be made from a single sheet of conductive material, (such as, e.g., metal) using stamping, or metal-stamping, techniques. For example, the main body 103, the first support 104, the second support 106, and the third support 108 may be formed from a single conductive sheet by cutting a predetermined shape from the sheet and bending, or molding, the predetermined shape to form the antenna structure 100 shown in FIG. 1. In some embodiments, the predetermined shape includes a long rectangular portion that includes the main body 103 with the side 109, the first end 105, and the second end 107, and a perpendicular “wing” or side portion that extends from the side 109 and includes the side protrusion 110. In such embodiments, the first support 104, the second support 106, and the third support 108 can be respectively formed by bending each of the first end 105, the second end 107, and the side protrusion 110 into an L-shaped, Z-shaped, S-shaped, or C-shaped structure.

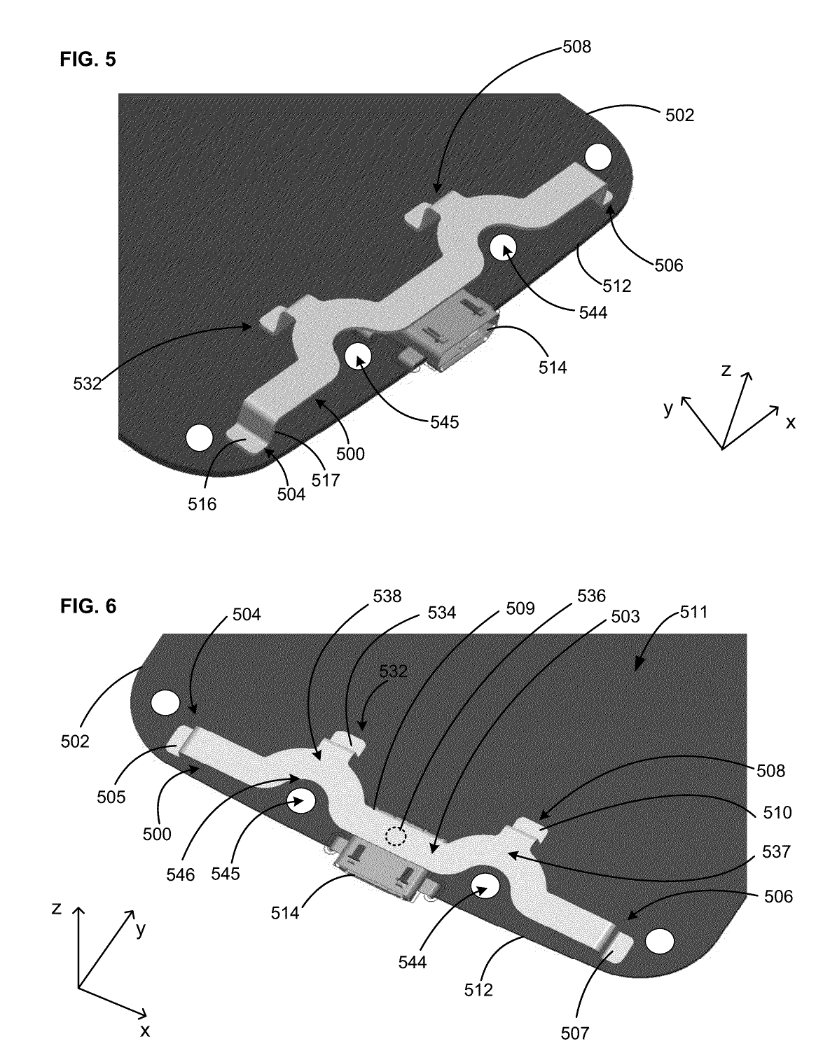

It should be appreciated that the antenna structure 100, as depicted, is merely an example and can have other physical characteristics, such as, other shapes, forms, and/or dimensions. For example, while the illustrated embodiment shows the antenna structure 100 with straight edges, in other embodiments the antenna structure 100 may have curved or other non-linear edges (e.g., as shown in FIGS. 5 and 6). As another example, while the illustrated embodiment shows the antenna structure 100 as having a length that spans across a majority portion of the PCB, in other embodiments the antenna structure 100 may have a length that is shorter or longer than the depicted length. In some embodiments, the length of the antenna structure 100 may be determined by an intended resonant frequency of the antenna structure 100. In some embodiments, if the antenna structure 100 is placed towards the edge (e.g., the y-axis bottom edge of the electronic device), a shape and/or curvature of a rear housing portion of the electronic device can determine or impact the physical aspects of the antenna structure 100, as well as the functional aspects, as the edges of an antenna typically correspond to the points of the antenna where electric current and radiation are the strongest. In some example embodiments, the antenna structure 100 may include additional supports coupled to the PCB 102 (for example, as shown in FIGS. 5 and 6) and/or may have more than three supports coupled to the PCB 102.

FIG. 2 depicts a side view of an example antenna structure 200 consistent with some embodiments. The antenna structure 200 may be similar to the antenna structure 100 described with respect to FIG. 1. For example, FIG. 2 may be considered an elevation view of the antenna structure 100. The antenna structure 200 may be included in any type of electronic device (not shown) that includes one or more wireless communications transmitters or receivers, such as, for example, a mobile communications device.

Like the antenna structure 100, the antenna structure 200 is a bridge-like structure that includes a plurality of supports attached to a surface of a printed circuit board (“PCB”) 202 and a main body 203 suspended above the PCB 202. As shown in FIG. 2, the antenna structure 200 includes a first support 204 formed at a first end 205 of the main body 203 and a second support 206 formed at a second end 207 of the main body 203. As shown in FIG. 2, the second end 207 is positioned opposite from the first end 205 along a length of the main body 203. The antenna structure 200 also includes a third support 208 extending from a side 209 of the main body 203. As shown, the side 209 extends between the first end 205 and the second end 207 along the length of the main body 203. In embodiments, the third support 208 is formed from a side protrusion 210 of the main body 203. For example, the side protrusion 210 can project or extend out from the side 209 of the main body 203 towards a center (not shown) of the PCB 202.

According to embodiments, attachment of the first support 204, the second support 206, and the third support 208 to the PCB 202 can cause the main body 203 of the antenna structure 200 to be suspended or elevated at a predetermined z-axis height 215 above the PCB 202. As shown in FIG. 2, each of the first support 204, the second support 206, and the third support 208 can be a substantially “L-shaped” structure that includes a horizontal base portion 216 capable of forming a parallel connection with the surface of the PCB 202 and a vertical support portion 217 that is perpendicular to the surface of the PCB 202. According to some aspects, the support portion 217 can form an approximately 90 degree angle with each of the base portion 216 and the main body 203. Other support configurations, such as a Z-shape, an S-shape, or a C-shape may also be used to support the main body. Note also that not all the supports need to use the same type of support configuration.

Also according to some aspects, a height of a vertical support portion 217 can determine the height of the antenna structure 200. For example, as shown in FIG. 2, each of the first support 204, the second support 206, and the third support 208 can have an overall height that is substantially equal to the predetermined height 215 of the main body 203. The exact dimensions of the base portion 216 and the support portion 217 may be selected based on a number of factors, including, for example, stability of the antenna structure 200, amount of available surface area on the PCB 202, overall design and contours of the housing of the electronic device, contact pad sizes (to be discussed below), metal-stamping configurations, and the dimensions of nearby conductive elements (as discussed below). Likewise, the exact angle at which the support portion 217 meets each of the base portion 216 and the main body 203 may be determined by a number of factors including, for example, stability of the antenna structure 200, metal-stamping configurations, structure of the electronic device, and clearance available above the PCB 202.

Also like the antenna structure 100, the antenna structure 200 may be capable of serving any of a number of antenna functions related to sending and receiving voice and/or data. In some embodiments, the antenna structure 200 may be a “multi-band” antenna tuned to a plurality of the frequency bands associated with the RATs supported by the PCB 202, or more specifically, wireless communication circuitry (not shown) included on the PCB 202. According to some embodiments, the antenna structure 200 may be coupled adjacent to a bottom end (not shown) of the PCB 202, which may correspond to the largest discrete antenna volume within the electronic device. In such embodiments, the antenna structure 200 may be configured as a main Tx/Rx antenna of the electronic device. In other embodiments, the antenna structure 100 may be placed at other locations of the PCB 202 that correspond to sufficiently large antenna volumes, such as, for example, the top left or right corners (not shown) of the PCB 202. In addition, the antenna structure 100 may be any suitable type of antenna, such as, e.g., an inverted L-antenna, dual inverted L-antenna, inverted-F antenna, or hybrids of these antenna structures.

According to embodiments, the bridge-like structure of the antenna structure 200 can allow the antenna structure 200 to be placed over, and out of contact with, other conductive elements (e.g., electronic components) of the PCB 202. For example, in the illustrated embodiment, the antenna structure 200 is suspended above a connector 214 that is also coupled adjacent to the y-axis bottom end of the PCB 202. As will be appreciated, other conductive elements may also be included under the antenna structure 200 but are not shown herein for the sake of simplicity. In embodiments, the predetermined height 215 of the main body 203 can be selected based on a height of any conductive elements located below, or adjacent to, the antenna structure 200. In the illustrated embodiment, the predetermined height of the main body 203 may be selected to be at least greater than a height of the connector 214, so to as to avoid contact between the connector 214 and the antenna structure 200. According to embodiments, the connector 214 may be any type of cable connector for connecting a charging and/or data cable (not shown) to the PCB 202. In the illustrated embodiment, the connector 214 is a female Universal Serial Bus (USB) connector (or “socket”) configured to receive a male USB connector (or “plug”).

As shown in FIG. 2, in some embodiments, an insulator 218 may be inserted between the antenna structure 200 and the connector 214 to further promote isolation of the antenna structure 200. In the illustrated embodiment, the insulator 218 is a non-conductive tape coupled to an underside of the main body 203. As an example, the insulator 218 may prevent accidental contact between the antenna structure 200 and the connector 214 if, for example, deformation of the antenna structure 200 causes the main body 203 to sag or bend down towards the connector 214. Alternatively or additionally, an insulator may be positioned on top of the connector 214 between the connector and the main body 203.

In embodiments, each of the first support 204, the second support 206, and the third support 208 can be mechanically attached to the PCB 202. According to some embodiments, at least one of the supports 204, 206, and 208 can be electrically coupled to an antenna feed (not shown) of the PCB 202, and the remaining two of the supports 204, 206, and 208 can be non-grounded (e.g., not forming an electrical connection with the PCB 202). In some embodiments, the PCB 202 can include a plurality of contact pads that are configured for attachment to the antenna structure 200. As shown in FIG. 2, a first contact pad 220 can be coupled to the first support 204, a second contact pad 222 can be coupled to the second support 206, and a third contact pad 224 can be coupled to the third support 208. In some embodiments, the third contact pad 224 may be electrically coupled to the antenna feed, thereby electrically coupling only the third support 208 to the antenna feed. And each of the first contact pad 220 and the second contact pad 222 can be a non-grounded contact pad, thereby ensuring that the first support 204 and the second support 206 are not electrically coupled to the PCB 202. According to some aspects, the contact pads 220, 222, and 224 may be placed on the PCB 202 at predetermined surface locations that correspond to an intended location of the antenna structure 200 on the PCB 202.

In some embodiments, each of the contact pads 220, 222, and 224 may include solder paste, or other conductive adhesive, for securing the supports 204, 206, and 208 thereto using, for example, a reflow soldering process. According to one example manufacturing process, the antenna structure 200 may be placed onto the PCB 202 so that the base portions 216 of the supports 204, 206, and 208 are respectively aligned with, and on top of, the contact pads 220, 224, and 226. When the antenna structure 200 and the PCB 202 undergo the reflow soldering process, the solder paste located between the supports 204, 206, and 208 and the respective contact pads 220, 224, and 226 is heated until melted and then cooled until solidified. Through this heating and cooling, the solder paste secures the supports 204, 206, and 208 to respective contact pads 220, 224, and 226.

According to embodiments, the antenna structure 200 can be made from a single sheet of conductive material, (such as, e.g., metal) using stamping, or metal-stamping techniques. For example, the main body 203, the first support 204, the second support 206, and the third support 208 may be formed from a single conductive sheet by cutting a predetermined shape from the sheet and bending the predetermined shape to form the antenna structure 200 shown in FIG. 2. In some embodiments, the predetermined shape has a long rectangular portion that includes the main body 203, the first end 205, the second end 207, and the side 209, and a perpendicular “wing” or side portion that extends from the side 209 and includes the side protrusion 210. In such embodiments, the first support 204, the second support 206, and the third support 208 can be respectively formed by bending each of the first end 205, the second end 207, and the side protrusion 210 into the L-shaped structure shown in FIG. 2.

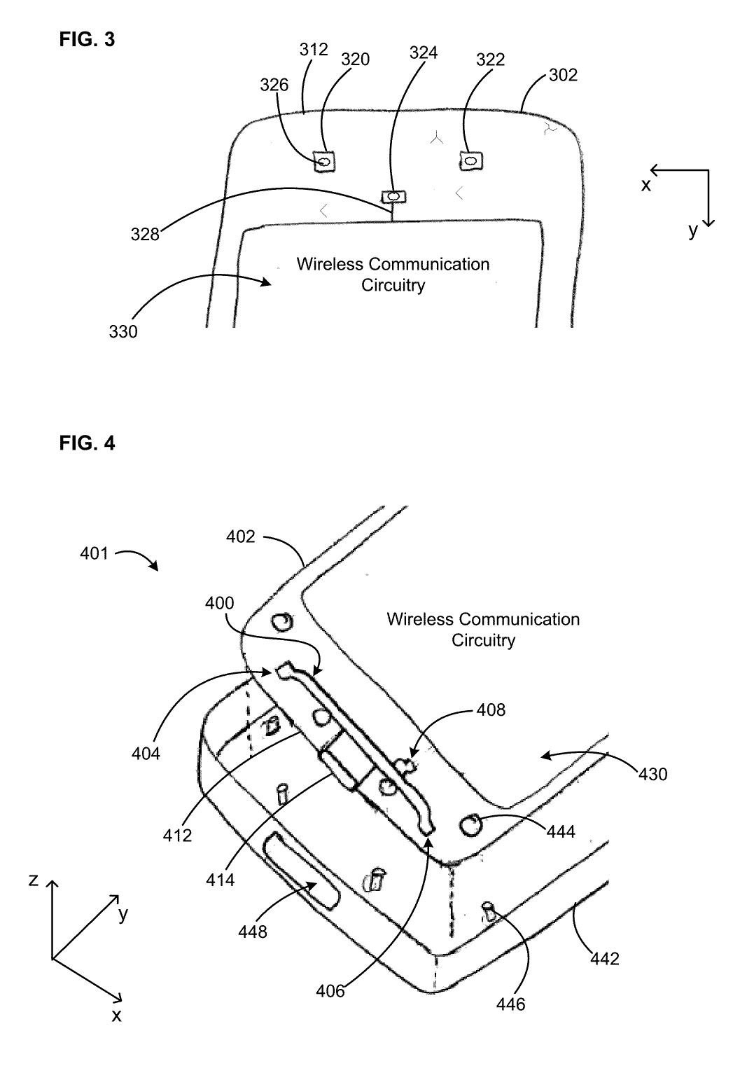

FIG. 3 depicts an upside-down view of an example printed circuit board (“PCB”) 302 consistent with some embodiments. The PCB 302 may be included in any type of electronic or mobile device (not shown) that includes one or more wireless communications devices, such as, for example, a mobile communications device. Further, the PCB 302 can be configured for attachment to a surface-mountable antenna (not shown) that includes a plurality of support legs for elevating a main body of the antenna above the PCB 302, similar to either, or both, of the antenna structure 100 shown in FIG. 1 and the antenna structure 200 shown in FIG. 2. As illustrated, the PCB 302 may include a first contact pad 320, a second contact pad 322, and a third contact pad 324 configured for attachment to the surface-mountable antenna, or more specifically, the support legs (e.g., similar to the supports 204, 206, and 208) of the antenna. According to embodiments, the contacts pads 320, 322, and 324 may be designated surface areas of the PCB 302 for contacting components of the mobile device. In some cases, the contact pads 320, 322, and 324 (also known as “solder pads”) may be tin, silver, or gold-plated copper pads. Each of the contact pads 320, 322, and 324 may include a conductive adhesive 326 (e.g., solder paste) on a surface thereof for securing the antenna to the contact pads 320, 322, and 324, for example, using a reflow soldering technique. According to one example embodiment, the contact pads 320, 322, and 324 may have a substantially square shape with a dimension of about 0.3 millimeters (mm). In other embodiments, the contact pads 320, 322, and 324 may have other dimensions depending on, for example, the amount of surface area available on the PCB 302.

The contact pads 320, 322, and 324 may be positioned on the PCB 302 in accordance with a configuration of the support legs of the surface-mountable antenna. For example, as shown in FIG. 3, the contact pads 320, 322, and 324 are positioned adjacent to a bottom 312 of the PCB 302, similar to the antennas 100 and 200 shown in FIGS. 1 and 2, respectively. Further, the first contact pad 320 is positioned opposite from the second contact pad 322, similar to the positioning of the second end 107 and the first end 105 of the antenna structure 100, as shown in FIG. 1. Likewise, the third contact pad 324 is placed between the first contact pad 320 and the second contact pad 322, but offset towards a center of the PCB 302, similar to the positioning of the side protrusion 110 of the antenna structure 100, as shown in FIG. 1.

In the illustrated embodiment, the PCB 302 includes a trace 328 for electrically coupling the third contact pad 324 to an antenna feed, or radio frequency (RF) lead, of the PCB 302, or more specifically, wireless communication circuitry 330 included on the PCB 302. For example, as shown in FIG. 3, the trace 328 may be an in-board or embedded antenna trace that extends from the third contact pad 324 to the wireless communication circuitry 330. According to embodiments, the wireless communication circuitry 330 can be configured to carry out the voice and/or data communications of the electronic device by passing signals to, and/or receiving signals from, the surface-mountable antenna. As shown in FIG. 3, the remaining contact pads, namely the first contact pad 320 and the second contact pad 322, are not coupled to the wireless communication circuitry 330. In some embodiments, the first contact pad 320 and the second contact pad 322 may be non-grounded to ensure a non-electrical connection with the PCB 302 at those two points.

FIG. 4 depicts an exploded partial view of an example antenna structure 400 housed within an electronic device 401 consistent with some embodiments. The electronic device 401 may be any type of mobile device that includes one or more wireless communications devices, such as, for example, a smartphone, a tablet, an e-reader, a portable gaming device, a portable media player, a personal digital assistant, a laptop computer, etc. As shown in FIG. 4, the antenna structure 400 is mounted on a surface of a printed circuit board (“PCB”) 402 included in the electronic device 401.

The antenna structure 400 may be similar to the antenna structure 100 and/or the antenna structure 200 described previously. For example, the antenna structure 400 can be made from a single sheet of conductive material (such as, e.g., metal) using stamping, or metal-stamping techniques, as described herein. Further, like the antenna structures 100 and 200, the antenna structure 400 forms a bridge-like structure that is elevated or suspended above the PCB 402 by a first support 404, a second support 406, and a third support 408 of the antenna structure 400. As shown in FIG. 4, each of the first support 404, the second support 406, and the third support 408 can be a substantially “L-shaped” structure that includes a horizontal base portion in substantially parallel connection with the surface of the PCB 402 and a vertical support portion that extends upwards (e.g., perpendicularly or on an incline) from the surface of the PCB 402. As shown in FIG. 4, a connector 414 can also be coupled to the PCB 402, and the antenna structure 400 extends over the connector 414 without making physical or electrical contact.

According to one example embodiment, the connector 414 is a USB connector for coupling a USB cable to the electronic device 401. A height of the antenna structure 400 may be selected so as to “clear” or be greater than an outer height of the connector 414. The exact dimensions and other physical characteristics of the antenna structure 400 may be selected based on a number of factors, including, for example, stability of the antenna structure 400, amount of available surface area on the PCB 402, contact pad sizes, metal-stamping configurations, dimensions of nearby conductive elements, metal-stamping configurations, structure of the electronic device 401, and amount of clearance available above the PCB 402 within the device housing.

According to embodiments, the antenna structure 400 is electrically coupled to an antenna feed (not shown) of the PCB 402, or more specifically, wireless communication circuitry 430 included on the PCB 402. In some embodiments, the third support 408 is electrically coupled to the wireless communication circuitry 430, and the remaining supports 404 and 406 may be only mechanically attached to the PCB 402. For example, the PCB 402 may include a plurality of contact pads (e.g., similar to the contact pads 320, 322, and 324 shown in FIG. 3) that are mechanically coupled to respective supports 404, 406, and 408 (e.g., using a conductive adhesive). Only one of the contact pads may be electrically coupled to the wireless communication circuitry 430 via an embedded antenna trace (e.g., similar to the trace 328 shown in FIG. 3), and the third support 408 may be coupled to the electrically coupled contact pad. The remaining contact pads, and therefore the remaining supports 404 and 406, may be non-grounded contact pads that are not electrically coupled to the PCB 402.

Similar to the antenna structures 100 and 200, the antenna structure 400 may be capable of serving any of a number of antenna functions related to sending and receiving voice and/or data. In some embodiments, the antenna structure 400 may be a “multi-band” antenna tuned to a plurality of the frequency bands associated with the RATs supported by the electronic device 401, or more specifically, the wireless communication circuitry 430. According to some embodiments, the antenna structure 400 may be coupled adjacent to a bottom end 412 of the PCB 402, which may correspond to the largest discrete antenna volume within the electronic device 401. In such embodiments, the antenna structure 400 may be configured as a main Tx/Rx antenna of the electronic device 401. In other embodiments, the antenna structure 400 may be placed at other locations of the PCB 402 that correspond to sufficiently large antenna volumes, such as, for example, the top left or top right corners (not shown) of the PCB 402. The antenna structure 400 may be any suitable type of antenna, such as, e.g., an inverted L-antenna, dual inverted L-antenna, inverted-F antenna, or variants of these antenna structures.

In embodiments, the wireless communication circuitry 430 may include, for example, a plurality of amplifiers, power inverters, filters, switches, matching networks (e.g., including one or more resisters, inductors, and/or capacitors), and other components typically found in the radio frequency (RF) front-end architecture of a mobile communications device. In some embodiments, the wireless communication circuitry 430, a control module (not shown), and/or a processor (not shown) of the electronic device 401 may determine which frequency band of operation to use for transmitting and/or receiving signals based on, for example, information received by the antenna 400 from one or more wireless communication system(s) (e.g., RAT(s)) related to spectral availability, region-specific information, signal strength, etc.

According to embodiments, the electronic device 401 may include a housing 442 that houses a majority of the electronic components included in the device 401, including the PCB 402. As will be appreciated, FIG. 4 shows only a partial view of the electronic device 401 and therefore, only a bottom portion of the housing 442 is visible in FIG. 4. The housing 442 may be composed of plastic, metal, or any other suitable materials and combinations thereof. As shown in FIG. 4, the PCB 402 may include one or more apertures 444 for receiving fasteners 446 included in the housing 442 for securing the PCB 402 to the housing 442. According to some embodiments, the fasteners 446 may be any type of mechanical fastener, including screws, bolts, pins, or heat-stakes. The housing 442 may further include an opening 448 aligned with the connector 414, for example, to provide user access to the connector 414.

Referring now to FIGS. 5 and 6, FIG. 5 depicts a side perspective view of an example antenna structure 500 consistent with some embodiments, and FIG. 6 depicts a top perspective view of the antenna structure 500 consistent with some embodiments. The antenna structure 500 may be included in any type of electronic or mobile device (e.g., similar to the electronic device 401 shown in FIG. 4) that includes one or more wireless communications devices, such as, for example, a mobile communications device.

As shown in FIGS. 5 and 6, the antenna structure 500 may be secured to a printed circuit board (“PCB”) 502 that includes apertures 544 and 545 (e.g., similar to the aperture 444 shown in FIG. 4) for securing the PCB 502 to a device housing (e.g., similar to the housing 442 shown in FIG. 4). In some embodiments, the antenna structure 500 may include two curved areas, or notches 546, adjacent to the apertures 544 and 545, so that the antenna structure 500 forms a “W” shape. The notches 546 may be configured to curve around or avoid the apertures 544 and 545 in order to allow room for any fasteners (e.g., similar to the fasteners 446 shown in FIG. 4) that may be inserted into the apertures 544 and 545. In the illustrated embodiment, the notches 546 coincide with a first location 537 and a second location 538 and thereby, also contribute to improving the overall balance of the antenna structure 500. As will be appreciated, in other embodiments, the notches 546 may be located at other areas of a main body 503 of the antenna structure 500 depending on where the apertures 544 and 545 are located. Further, the amount of curvature of the notches 546 may be determined by a number of factors, including, for example, the curvature of the apertures 544 and 545, the existence of conductive elements adjacent to the notches 546, a shape of a connector 514 coupled below the antenna structure 500, and a shape of the housing adjacent to a bottom end 512 of the PCB 502.

According to embodiments, the antenna structure 500 may be a bridge-like structure that includes a plurality of supports 504, 506, 508, 532 attached to a surface of the PCB 502 and the main body 503, which is suspended above the PCB 502. As shown in FIG. 6, the antenna structure 500 includes a first support 504 formed at a first end 505 of the main body 503 and a second support 506 formed at a second end 507 of the main body 503. As also shown in FIG. 6, the second end 507 is positioned opposite from the first end 505 along a length of the main body 503. The antenna structure 500 also includes a third support 508 extending from a side 509 of the main body 503. In addition, the antenna structure 500 may include a fourth support 532 that also extends from the side 509 of the main body 503, like the third support 508. As shown in FIG. 6, the side 509 extends between the first end 505 and the second end 507 along the length of the main body 503. In embodiments, the third support 508 is formed from a first side protrusion 510 of the main body 503, and the fourth support 532 may be formed from a second side protrusion 534 of the main body 503. As an example, the side protrusions 510 and 534 may project or extend out from the side 509 of the main body 503 towards a central portion 511 of the PCB 502.

In embodiments, attachment of the first support 504, the second support 506, the third support 508, and the fourth support 532 to the PCB 202 can cause the main body 503 of the antenna structure 500 to be suspended or elevated at a predetermined height above the PCB 502. As shown in FIG. 5, each of the first support 504, the second support 506, the third support 508, and the fourth support 532 can be a substantially “L-shaped” structure that includes a horizontal base portion 516 capable of forming a substantially parallel connection with the surface of the PCB 502 and a vertical support portion 517 that extends upwards (e.g., perpendicularly or at an incline) from the surface of the PCB 502. According to some aspects, the vertical support portion 517 for each of the supports 504, 506, 508, and 532 can form an approximately 90 degree angle with each of the horizontal base portion 516 and the main body 503. According to other aspects, the vertical support portion 517 for one or more of the supports 504, 506, 508, and 532 can meet the horizontal base portion 516 and/or the main body 503 at an incline, or at an angle that is less than or greater than 90 degrees. Also, according to some aspects, a height of the vertical support portion 517 for each of the supports 504, 506, 508, and 532 can determine the height of the antenna structure 500. For example, each of the supports 504, 506, 508, and 532 can have an overall height that is substantially equal to the predetermined height of the main body 503.

The exact dimensions of the base portion 516 and the support portion 517 may be selected based on a number of factors, including, for example, stability of the antenna structure 500, amount of available surface area on the PCB 502, contact pad sizes, metal-stamping configurations, device housing dimensions and contours, and the dimensions of nearby conductive elements. Likewise, the exact angle at which the support portion 517 meets each of the base portion 516 and the main body 503 may be determined by a number of factors including, for example, stability of the antenna structure 500, metal-stamping configurations, structural characteristics of the device housing, and amount of clearance available above the PCB 502.

The antenna structure 500 may be capable of serving any of a number of antenna functions related to sending and receiving voice and/or data. In some embodiments, the antenna structure 500 may be a “multi-band” antenna tuned to a plurality of the frequency bands associated with the RATs supported by the PCB 502, or more specifically, wireless communication circuitry (e.g., similar to the wireless communication circuitry 430 shown in FIG. 4) included on the PCB 502. According to some embodiments, the antenna structure 500 may be coupled adjacent to a bottom end 512 of the PCB 502, which may correspond to the largest discrete antenna volume within the electronic device. In such embodiments, the antenna structure 500 may be configured as a main Tx/Rx antenna of the electronic device. In other embodiments, the antenna structure 500 may be placed at other locations of the PCB 502 that correspond to sufficiently large antenna volumes, such as, for example, the top left or right corners (not shown) of the PCB 502. In addition, the antenna structure 500 may be any suitable type of antenna, such as, e.g., an inverted L-antenna, dual inverted L-antenna, inverted-F antenna, or hybrids of these antenna structures.

According to embodiments, the bridge-like structure of the antenna structure 500 can allow the antenna structure 500 to be placed over, and out of contact with, other conductive elements (e.g., electronic components) of the PCB 502. For example, in the illustrated embodiment, the antenna structure 500 is suspended above a connector 514 that is also coupled adjacent to the bottom end 512 of the PCB 502. As will be appreciated, other conductive elements may also be included under the antenna structure 500 but are not shown herein for the sake of simplicity. In embodiments, the predetermined height of the main body 503 can be selected based on a height of any conductive elements located below, or adjacent to, the antenna structure 502. In the illustrated embodiment, the predetermined height of the main body 503 may be selected to be at least greater than a height of the connector 514, so to as to avoid contact between the connector 514 and the antenna structure 500. According to embodiments, the connector 514 may be any type of cable connector for connecting a charging and/or data cable (not shown) to the PCB 502. In the illustrated embodiment, the connector 514 is a female Universal Serial Bus (USB) connector (or “socket”) configured to receive a male USB connector (or “plug”).

In embodiments, each of the first support 504, the second support 506, the third support 508, and the fourth support 532 can be mechanically attached to the PCB 502. According to some embodiments, only one of the supports 504, 506, and 508 is electrically coupled to an antenna feed (not shown) of the PCB 502, and the remaining three of the supports 504, 506, 508, and 532 can be non-grounded (e.g., not forming an electrical connection with the PCB 502). In some embodiments, the PCB 502 can include a plurality of contact pads (e.g., similar to the contact pads 320, 322, and 324 shown in FIG. 3) that are configured for attachment to the base portions 516 of respective supports 504, 506, 508, and 532. According to some aspects, the contact pads may be placed on the PCB 502 at predetermined surface locations that correspond to an intended location of the antenna structure 500 on the PCB 502. In some embodiments, the contact pad designated for the third support 508 may be electrically coupled to the antenna feed of the PCB 502, thereby electrically coupling the third support 508 to the antenna feed. And the remaining contact pads can be non-grounded contact pads, thereby ensuring that the first support 504, the second support 506, and the fourth support 532 are not electrically coupled to the PCB 502. In some embodiments, each of the contact pads may include solder paste, or other conductive adhesive, for securing the supports 504, 506, 508, and 532 thereto using, for example, a reflow soldering process.

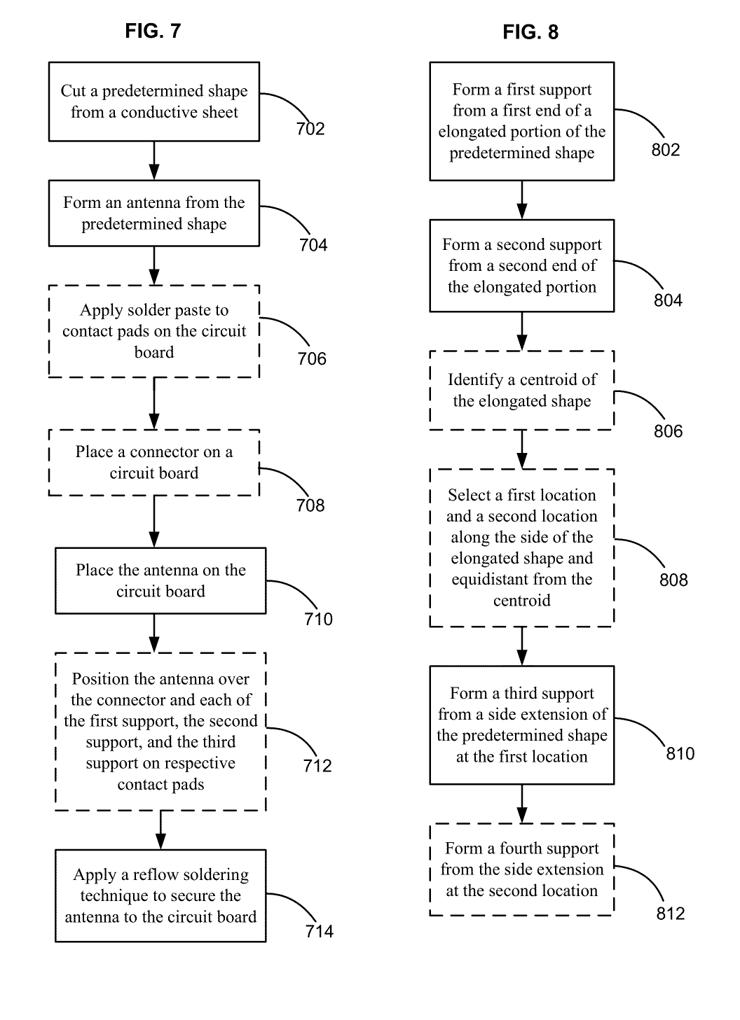

In some embodiments, the first side protrusion 510 and the second side protrusion 534 may be positioned along the side 509 in accordance with a centroid 536, or a balance center, of the main body 503, so that the antenna structure 500 is symmetrical and/or balanced overall. For example, the first side protrusion 510 may be located at the first location 537 along the side 509, and the second side protrusion 534 may be located at the second location 538 along the side 509. According to some aspects, the first location 537 and the second location 538 may be substantially equidistant from the centroid 536 along the side 509. Also according to some aspects, a distance between the first location 537 and the second end 507 along the side 509 may be substantially equal to a distance between the second location 538 and the first end 505 along the side 509. By balancing the entire antenna structure 500, maneuvering of the antenna structure 500 during the manufacturing process, particularly during mechanized placement of the antenna structure 500 on the PCB 502, may become easier and more efficient (to be discussed in more detail with respect to FIG. 7).

According to embodiments, the antenna structure 500 can be made from a single sheet of conductive material, (such as, e.g., metal) using stamping or metal-stamping techniques. For example, the main body 503, the first support 504, the second support 506, the third support 508, and the fourth support 532 may be formed from a single conductive sheet by cutting a predetermined shape from the sheet and bending the predetermined shape to form the antenna structure 500 shown in FIGS. 5 and 6. In some embodiments, the predetermined shape has an elongated portion that includes the main body 503, the first end 505, the second end 507, and the side 509.

In addition, the predetermined shape can include the first side protrusion 510 and the second side protrusion 534, each extending from the side 509 of the main body 503. Each of the first support 504, the second support 506, the third support 508, and the fourth support 532 can be formed by respectively bending each of the first end 505, the second end 507, the first side protrusion 510, and the second side protrusion 534 into the L-shaped structure shown in FIGS. 5 and 6.

In other embodiments, the predetermined shape may include a single side protrusion (e.g., rather than both the first side protrusion 510 and the second side protrusion 534) and both the third support 508 and the fourth support 532 may be formed from this single side protrusion. For example, the single side protrusion may span across the centroid 536 and be wide enough to encompass both the first location 537 and the second location 538. During the metal-stamping process, the excess metal extending between the third support 508 and the fourth support 532 may be cut and/or removed, in order to form the shape shown in FIGS. 5 and 6.

FIG. 7 is a flowchart of a method 700 for manufacturing and assembling a surface-mountable antenna (such as, e.g., the antenna structure 400 shown in FIG. 4) for an electronic device (such as, e.g., the electronic device 401 shown in FIG. 4) consistent with some embodiments. It is understood that the order of the steps of the depicted flowchart of FIG. 7 can be in any order, and certain ones can be eliminated, and/or certain other ones can be added depending upon the implementation.

The method 700 begins at step 702, where a predetermined shape is cut from a sheet of conductive material. According to embodiments, the predetermined shape can include an elongated portion (such as, e.g., the main body 103 shown in FIG. 1) and a side extension (such as, e.g., the side protrusion 110 shown in FIG. 1) extending from a side (such as, e.g., the side 109 shown in FIG. 1) of the elongated portion. In some embodiments, the predetermined shape further includes a second side extension (such as, e.g., the second side protrusion 534 shown in FIG. 6) coupled to the elongated portion. In some embodiments, the elongated portion has a generally rectangular shape (for example, as shown by the main body 103 in FIG. 1). In other embodiments, the elongated portion has a generally wavy, meandered, or curvy shape (for example, as shown by the main body 503 in FIG. 6). From step 702, the method 700 continues to step 704, where the antenna is formed from the predetermined shape.

FIG. 8 is a flowchart of a method 800 for forming the antenna from the predetermined shape consistent with some embodiments. The method 800 may be considered to be a sub-process included within the method 700 at step 704. In some embodiments, steps 702 and 704, along with the method 800, may be part of a metal-stamping technique that is applied to the conductive sheet to form the antenna. For example, a blanking press may be used at step 702 to punch out the predetermined shape from the conductive sheet, where the predetermined shape generally matches the size and shape of the antenna. From the blanking press, the predetermined shape may be sent to a plastic reel or transfer press, at step 704, in order to draw or stamp out the shape of the antenna, trim any excess material from the predetermined shape, and apply any bending that may be required to form the bridge-like structure of the antenna. In some cases, the stamping and drawing technique may need to be applied several times in order to build up the desired antenna shape. Metal-stamping techniques are known to those skilled in the art and therefore, will not be described in great detail herein.

Referring back to the method 800, at step 802, a first support (e.g., the first support 204 shown in FIG. 2) is formed from a first end (e.g., the first end 205 shown in FIG. 2) of the elongated portion of the predetermined shape, for example, by bending the first end into an L-shape. The method 800 further includes, at step 804, forming a second support (e.g., the second support 206 shown in FIG. 2) from a second end (e.g., the second end 207 shown in FIG. 2) of the elongated portion of the predetermined shape, for example, by bending the second end into an L-shape. In embodiments, the second end may be opposite from the first end (e.g., as shown in FIG. 2).

According to some embodiments, the method 800 also includes, at step 806, identifying a centroid (e.g., the centroid 536 shown in FIG. 5) of the elongated shape, and at step 808, selecting a first location (e.g., the first location 537 shown in FIG. 5) and a second location (e.g., the second location 538 shown in FIG. 5) along the side of the elongated shape. In some embodiments, the first location and the second location are substantially equidistant from the centroid. At step 810, the method 800 includes forming a third support (e.g., the third support 208) from the side extension of the predetermined shape, for example, by bending the side extension into an L-shape. In some embodiments, the side extension is positioned at the first location between the first end and the second end of the elongated portion. At step 812, the method 800 includes forming a fourth support (e.g., the fourth support 532 shown in FIG. 5) from the second side extension of the predetermined shape, for example, by bending the second side extension into an L-shape. In some embodiments, the second side extension is positioned at the second location between the first end and the second end of the elongated portion.

According to some embodiments, after completion of the method 800, the method 700 may continue to step 706, which includes applying, printing, or otherwise depositing solder paste (e.g., the solder paste 326 shown in FIG. 3) on to each of a plurality of contact pads (e.g., the contact pads 320, 322, and 324 shown in FIG. 3) included on a circuit board (such as, for example, the PCB 302 shown in FIG. 3). Also according to some embodiments, the method 700 may include step 708, wherein a connector (e.g., the connector 114 shown in FIG. 1) is placed on the circuit board. In one example embodiment, the connector is a female USB connector configured to receive a USB cable plug.

From step 706 or 708, the method 700 continues to step 710, where the antenna is placed on the circuit board of the electronic device. In some embodiments, the method 700 includes, at step 712, positioning each of the first support, the second support, and the third support on the respective contact pads, for example, on top of the solder paste deposited on the contact pads. In some embodiments, step 712 further includes positioning the antenna above or over the connector without causing contact between the two units, for example, so that the antenna forms a bridge over the connector. As an example, steps 710 and 712 may be carried out using a “pick-and-place machine” that uses a vacuum component to apply vacuum pressure or suction to the antenna and thereby, pick up and hold the antenna as it is moved to the circuit board. Once the antenna is properly positioned over the circuit board, the vacuum pressure may be released in order to place the antenna on the board. In some embodiments, the antenna is composed of a lightweight, conductive material and therefore, a very small vacuum nozzle may be required to maneuver the antenna. As another example, steps 710 and 712 may be carried out by using a high temperature tape to pick up the antenna and move the antenna onto the circuit board.

At step 714, a reflow soldering technique is applied to the antenna to secure the first support, the second support, and the third support to respective contact pads included on the circuit board. According to some embodiments, the reflow soldering technique is applied to both the antenna and the connector at the same time (e.g., by sending the entire circuit board into a “reflow soldering oven”), so as to simultaneously secure the antenna and the connector to the circuit board. As an example, the reflow soldering process may include heating both the antenna and the solder paste, so that the solder paste melts around the supports of the antenna, and then cooling the same, so that the antenna and solder paste form one unit after the solder paste solidifies. Reflow soldering techniques are well known in the art and thus, will not be discussed in further detail herein.

In embodiments where the third support and the fourth support are placed at the first and second locations, respectively, the antenna may have a generally symmetrical shape, for example as shown in FIGS. 5 and 6. In embodiments that only include the first support, the second support, and the third support, the antenna may have a generally asymmetrical shape, for example, as shown in FIG. 1. According to certain aspects, the symmetrically-shaped antenna may provide certain manufacturing efficiencies, for example, as compared to the asymmetrically-shaped antenna. For example, the symmetrical antenna may be easier to balance when maneuvering the antenna during placement onto the circuit board (as discussed above with respect to steps 710 and 712). In comparison, the asymmetrical antenna may require an extra step to counter the off-balanced nature of its shape. However, the asymmetrical antenna has the advantage of requiring fewer contact pads and less conductive material. Thus, both antenna designs can be advantageous.

Thus, it will be appreciated that the systems and methods disclosed herein provide a stamped, surface mountable antenna with a three-dimensional, bridge-like structure that has advantages over existing antennas. For example, most commercially-available antennas (including existing metal-stamped antennas) are coupled to the rear housing of the mobile device and therefore, require a metal spring contact to form an electrical contact with a circuit board of the mobile device. Metal spring contacts can be costly to implement, for example, because they can be difficult to manufacture and assemble. Metal spring contacts can also be less reliable at least because they can be easily deformed or knocked out of place during normal use of the mobile device. The stamped, surface-mountable antenna disclosed herein is directly attached to the circuit board of the mobile device and therefore, does not require a metal spring contact for making electrical connection with the circuit board. As shown in FIGS. 1-2, the antenna does not have to be symmetrical. If the antenna has a centroid that is large enough, a pick-and-place machine can accurately place the antenna on the PCB easily. Other configurations are available to improve pick-and-place yield and accuracy, such as the line symmetry shown in FIGS. 5-6 and point-symmetrical configurations.

As another example, commercially-available surface-mountable antennas (such as, for example, “ceramic-chip” antennas) are typically constructed on a dielectric substrate and has at least one leg grounded. Ceramic-chip antennas also have a capacitively-fed radio frequency connection with the circuit board. Moreover, existing ceramic-chip antennas are single-band antennas with bandwidths that are typically 100 MHz or less. The stamped, surface-mountable antenna disclosed herein provides a more reliable RF connection by directly connecting only one of the support legs to an antenna feed of the circuit board, and using the remaining legs as non-grounded supports that provided only mechanical support. In addition, the antenna disclosed herein can be a multi-band antenna with a bandwidth that is at least similar to existing multi-band antennas.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. An antenna structure configured for attachment to a circuit board of an electronic device, comprising:
a main body having a first end, a second end opposite from the first end, and a side extending between the first end and the second end;
a first support formed from the first end of the main body;
a second support formed from the second end of the main body; and
a third support extending from the side of the main body,
wherein the main body, the first support, the second support, and the third support are formed from a single conductive sheet, and
wherein upon attachment to the circuit board, each of the first support, the second support, and the third support is mechanically attached to the circuit board, and only one of the first support, the second support, and the third support is electrically coupled to an antenna feed of the circuit board.

2. The antenna structure of claim 1, wherein upon attachment to the circuit board, the third support is electrically coupled to the antenna feed.

3. The antenna structure of claim 1, wherein upon attachment of the first support, the second support, and the third support to the circuit board, the main body is suspended at least a predetermined height above the circuit board.

4. The antenna structure of claim 3, wherein each of the first support, the second support, and the third support has a height substantially equal to the predetermined height.

5. The antenna structure of claim 1, further comprising a fourth support extending from the side of the main body, the fourth support being formed from the single conductive sheet.

6. The antenna structure of claim 5, wherein a first distance along the side of the main body between the second end and the third support is substantially equal to a second distance along the side of the main body between the first end and the fourth support.

7. An electronic device, comprising:
an antenna configured to operate in a plurality of frequency bands, the antenna including:
a conductive body having a first end, a second end opposite from the first end, and a side extending between the first end and the second end;
a first support formed from the first end of the conductive body,
a second support formed from the second end of the conductive body, and
a third support extending from the side of the conductive body; and
a circuit board including:
wireless communication circuitry configured to pass signals to, and/or receive signals from, the antenna, and
a plurality of contact pads configured for attachment to the antenna, wherein a select one of the plurality of contact pads is coupled to the wireless communication circuitry.

8. The electronic device of claim 7, wherein each of plurality of contact pads is coupled to a respective one of the first support, the second support, and the third support.

9. The electronic device of claim 8, wherein the select one of the plurality of contact pads is coupled to the third support.

10. The electronic device of claim 8, wherein the plurality of contact pads includes at least two non-grounded contact pads.

11. The electronic device of claim 10, where the first support and the second support are coupled to respective ones of the at least two non-grounded contact pads.

12. The electronic device of claim 11, the antenna further including a fourth support extending from the side of the conductive body, the fourth support being coupled to a respective one of the at least two non-grounded contact pads.

13. The electronic device of claim 7, wherein the circuit board further includes a connector, and the conductive body is suspended above the connector.

14. A method of manufacturing and assembling a surface-mountable antenna for an electronic device, the method comprising:
cutting a predetermined shape from a sheet of conductive material, the predetermined shape including an elongated portion and a side extension coupled thereto;
forming the antenna from the predetermined shape by:
forming a first support from a first end of the elongated portion of the predetermined shape,
forming a second support from a second end of the elongated portion of the predetermined shape, the second end being opposite from the first end, and
forming a third support from the side extension of the predetermined shape, the side extension being positioned between the first end and the second end of the elongated portion;
placing the antenna on a circuit board of the electronic device; and
applying a reflow soldering technique to secure the first support, the second support, and the third support to respective contact pads included on the circuit board.

15. The method of claim 14, wherein forming the antenna includes applying a metal stamping technique to the predetermined shape.

16. The method of claim 14, wherein forming the antenna further includes forming a fourth support from a second side extension of the predetermined shape.

17. The method of claim 16, wherein forming the antenna further includes:
identifying a centroid of the elongated portion;
selecting a first location and a second location along the side of the elongated portion, the first location and the second location being equidistant from the centroid;
forming the third support at the first location; and
forming the fourth support at the second location.

18. The method of claim 14, further comprising: prior to placing the antenna, placing a connector on the circuit board.

19. The method of claim 18, wherein placing the antenna includes positioning the antenna above the connector.

20. The method of claim 18, wherein applying the reflow soldering technique includes simultaneously securing the antenna and the connector to the circuit board.
